(19) United States
(12) Patent Application Publication
(10) Pub. No.: US 2025/0353715 A1
(43) Pub. Date: Nov. 20, 2025

(54) AUTONOMOUS FORKLIFT TRUCK FOR LIFTING AND TRANSPORTING A LOAD, AND ASSOCIATED METHOD

(71) Applicant: COMPAGNIE GENERALE DES ETABLISSEMENTS MICHELIN, Clermont-Ferrand (FR)

(72) Inventors: YANN BINDA, Clermont-Ferrand (FR); FLORIAN FAURE, Clermont-Ferrand (FR); KEVIN BOUVET, Clermont-Ferrand (FR)

(21) Appl. No.: 18/876,126

(22) PCT Filed: Jun. 14, 2023
(86) PCT No.: PCT/FR2023/050865

§ 371 Date: Dec. 17, 2024

(30) Foreign Application Priority Data
Jun. 22, 2022 (FR) FR2206207

(51) Int. Cl. B66F 9/06; B66F 9/075

(52) U.S. Cl. CPC B66F 9/063; B66F 9/0755

(57) ABSTRACT

This autonomous lift truck (1) comprises: a vertically mobile fork (4) equipped with at least two blades (4a, 4b) for lifting loads, a drive system (7) for moving the truck, and a control unit (9) able to command the operation of the drive system for autonomously guiding the truck and able to command the vertical movement of the fork (4). The truck further comprises a contactless load-detection device (10) able to move together with the fork and positioned above the blades (4a, 4b) of the fork. The contactless detection device (10) is able to emit a beam of light that sweeps at least a predefined planar detection zone situated above the blades of the fork so as to detect the presence of a load that is to be lifted.

### TECHNICAL FIELD

The present invention relates to the field of autonomous vehicles for the automated transportation of loads, such as autonomous lift trucks.

### PRIOR ART

Autonomous vehicles for transporting loads are being increasingly used to increase productivity and improve logistics management in factories or in warehouses.

Automated lift trucks are one example of such vehicles and make it possible for example for a load to be loaded, transported and positioned at height without human intervention.

However, in environments such as factories or warehouses, human intervention is still required in addition to the automated operations, for example to check that these operations are progressing correctly or to perform tasks that cannot be carried out by machines alone. These environments are therefore shared between humans and autonomous machines.

Personal safety is of fundamental importance in such working environments and accordingly requires that specific procedures be put in place.

For example, in order to limit the risk of the transported loads falling, the lift trucks are conventionally fitted with mechanical sensors placed on the vertical uprights of the fork used for lifting and transporting these loads.

Such mechanical sensors take the form of end-stops that pivot between a deployed position corresponding to a load that is absent or not in abutment against said end-stop, and a retracted position corresponding to a load that is in abutment against said end-stop.

However, when loads are picked from storage shelving, it is often difficult for the fork to reach a position that allows the mechanical sensors installed at the back of the fork to detect the presence of the load that is to be moved. Such is notably the case when the load that is to be collected is set back towards the inside of the shelving. It then sometimes becomes necessary to replace the existing storage shelving with shelving of a different design.

In order to overcome this disadvantage, one solution is to equip the lift trucks with telemeters.

However, telemeters which use a point measurement system are not able to detect all types of load. Such may for example be the case when the load that is to be detected has holes or else bores, as is notably the case with tyres.

### DISCLOSURE OF THE INVENTION

In the light of the foregoing, the object of the invention is therefore to propose an autonomous lift truck capable of remote and contactless detection of the loads that are to be transported, with a high level of reliability of detection, irrespective of the size or shape of the loads that are to be detected.

One subject of the invention is an autonomous lift truck comprising a vertically mobile fork equipped with at least two blades for lifting loads, a drive system for moving the lift truck, and a control unit able to command the operation of the drive system for autonomously guiding the lift truck.

According to one general feature, the lift truck further comprises a contactless load-detection device, said detection device being able to move together with the fork and positioned above the blades of said fork.

The detection device is able to emit a beam of light that sweeps at least a predefined planar detection zone situated above at least one of the blades of the fork so as to detect the presence or absence of a load that is to be lifted.

According to another general feature, the control unit receives information indicative of the presence or absence of the load that is to be lifted in said predefined planar detection zone and coming from the contactless detection device.

According to another general feature, the control unit is able to command the operation of the drive system and the vertical movement of the fork on the basis of this information.

Incorporating such a contactless detection device makes it possible to detect all types of load remotely, thereby increasing the level of reliability and of safety in comparison with the conventional detections.

It also becomes possible to collect a load “at the tip of the fork” of the truck safely. Thus, there is no need to modify the design of the existing storage shelving.

Advantageously, said predefined planar detection zone swept by the beam of light emitted by the contactless detection device is horizontal.

As a preference, said predefined planar detection zone swept by the beam of light emitted by the contactless detection device is situated above the two blades. In that case, said planar detection zone may extend laterally at least partially beyond the transverse spread of said blades of the fork.

As a variant, the contactless detection device may sweep two distinct planar detection zones, namely a first predefined planar detection zone situated above a first blade of the fork, and a second predefined planar detection zone situated above a second blade of the fork, different from the first blade.

According to another feature, the fork comprises at least two uprights supporting the blades, the contactless detection device being placed on one of the uprights.

In one particular embodiment, the autonomous lift truck further comprises an end-stop placed on each of the uprights of the fork and mounted with the ability to pivot between a deployed position corresponding to a load that is absent or not in abutment against said end-stop, and a retracted position corresponding to a load that is in abutment against said end-stop, the contactless detection device placed on said upright being situated above the associated end-stop. Alternatively, it remains possible to plan for the truck not to be equipped with these end-stops.

The autonomous lift truck comprises an on-board locator device configured to acquire position data pertaining to the position of the lift truck and communicating with the control unit. The contactless detection device is preferably distinct from the locator device.

Another aspect of the invention relates to a method for lifting and transporting a load using an autonomous lift truck as described hereinabove.

The lifting and transporting method comprises:
a step of positioning of the blades of the fork with respect to the load,
at least a first step of detection of the load by the contactless detection device,
a step of lifting of the load if the load is detected in at least a first predefined planar detection zone swept by the beam of light emitted by the contactless detection device in the first detection step, and
a step of movement of the autonomous lift truck and of transporting of the load.

For example, the first predefined detection zone is defined by four points delimiting a rectangle.

In one particular embodiment, the method may comprise, prior to the step of lifting of the load, a second step of successive detection of the load by the contactless detection device, the step of lifting of the load being performed if the load is detected during the second detection step.

For example, the step of lifting of the load is performed after a timeout step itself performed after the first detection step.

As a preference, the second load-detection step is performed in at least a second predefined detection zone situated inside said first detection zone on the side of the contactless detection device.

In one embodiment, said load-detection step is performed in a planar detection zone that is common to the blades of the fork.

In another embodiment, said load-detection step is performed in two distinct planar detection zones each specific to one of the two blades of the fork.

According to one feature, the method may comprise, during the step of movement of the autonomous lift truck and of transporting of the load, a sub-step of checking of the rotation of the load, performed by the contactless detection device, the checking of the rotation of the load being performed with respect to each detection zone that is specific to one of the two blades of the fork, the step of movement of the autonomous lift truck and of transporting of the load being halted if the load is not detected in said two detection zones simultaneously.

According to another feature, the method may comprise, during the step of movement of the autonomous lift truck and of transporting of the load, a sub-step of checking of the position of the load, performed by the contactless detection device, the checking of the position of the load being performed with respect to said first detection zone, the step of movement of the autonomous lift truck and of transporting of the load being halted if the load is not detected in said first detection zone.

According to another feature, the method may comprise, during the step of movement of the autonomous lift truck and of transporting of the load, a sub-step of checking of the position of the load, performed by the contactless detection device, the checking of the position of the load being performed with respect to at least one predefined detection zone indicative of a slippage of the load and situated outside said first detection zone on the side of the contactless detection device, the step of movement of the autonomous lift truck and of transporting of the load being halted if the load is detected in said predefined detection zone indicative of a slippage of the load.

### BRIEF DESCRIPTION OF THE FIGURES

Other objectives, features and advantages of the invention will become apparent on reading the following description given solely by way of nonlimiting example and with reference to the appended drawings in which:

FIG. 1 is a perspective view of an autonomous lift truck according to one exemplary embodiment of the invention;

FIG. 2 schematically illustrates the lift truck of FIG. 1, while it is in use;

FIG. 3 is a partial view, from above, of the lift truck of FIG. 1, and schematically depicts a first load-detection zone;

FIG. 4 illustrates the flow diagram for a method for lifting and transporting a load according to one embodiment of the invention;

FIG. 5 is a partial view, from above, of the lift truck of FIG. 1, and schematically depicts two load-tipping detection zones;

FIG. 6 illustrates a flow diagram for a method for lifting and transporting a load according to another embodiment of the invention;

FIG. 7 is a partial view, from above, of the lift truck of FIG. 1, and schematically depicts first and second load-detection zones;

FIG. 8 illustrates a flow diagram for a method for lifting and transporting a load according to another embodiment of the invention; and

FIG. 9 is a partial view, from above, of the lift truck of FIG. 1, and schematically depicts a load-slippage detection zone.

### DETAILED DESCRIPTION OF AT LEAST ONE EMBODIMENT

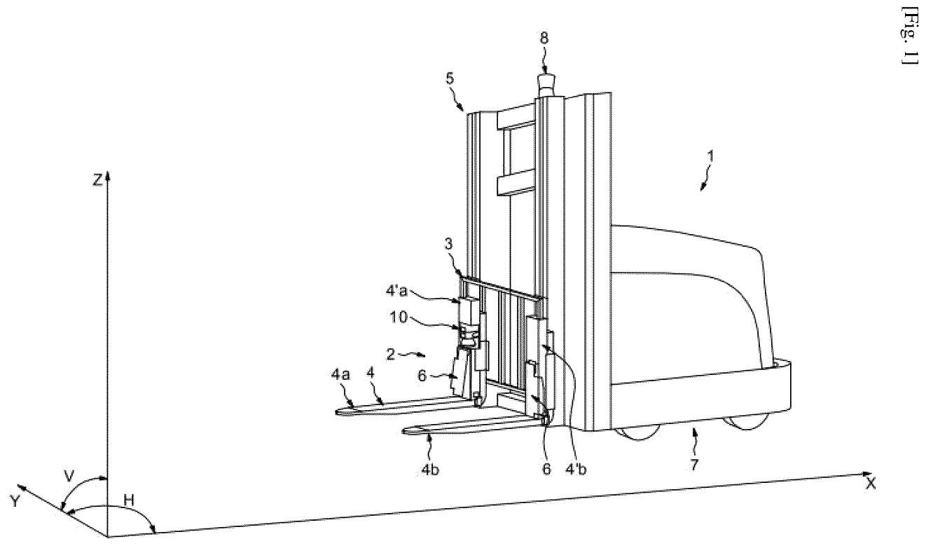

FIG. 1 depicts the main elements of an autonomous lift truck 1 according to one embodiment of the invention.

The architecture of the lift truck 1 is given by way of example and does not restrict the invention to the architectural configuration depicted alone. It must be understood that the invention also relates to lift trucks designed to operate in manual mode and which have been adapted to allow a second mode of operation which is an automatic mode.

The autonomous lift truck 1 illustrated in FIG. 1 comprises a fork carriage 3 equipped with a fork 4 comprising two blades 4a, 4b spaced apart laterally and extending forwards. The fork 4 also comprises two uprights 4′a, 4′b, each supporting one of the blades 4a, 4b.

The blades 4a, 4b of the fork are generally used such as to be inserted into entry openings provided in the transport pallets supporting the loads that are to be lifted. The uprights 4′a, 4′b allow the blades 4a, 4b to be raised so that a pallet that is to be transported or some other type of load can be lifted and so that a pallet or some other type of load can be positioned or collected at height.

The fork 4 is able to move translationally in a vertical plane V defined by the fork carriage 3, along a vertical mast 5 of the truck. The uprights 4′a, 4′b are able to slide along the mast 5. The blades 4a, 4b of the fork are parallel. The longitudinal axes of the blades 4a, 4b of the fork 4 are parallel. These longitudinal axes are oriented parallel to a horizontal axis X and define a horizontal plane H referred to as the lifting plane. The blades 4a, 4b of the fork 4 are perpendicular to the vertical plane V. The blades 4a, 4b of the fork also preferably able to be moved laterally relative to one another.

As a variant, the blades of the fork 4 may also be telescopic or retractable and/or able to be oriented angularly about their longitudinal axis.

In the exemplary embodiment illustrated, the truck 1 further comprises a mechanical end-stop 6 placed on each of the uprights 4′a, 4′b of the fork and mounted with the ability to pivot between a deployed position corresponding to a load that is absent or not in abutment against said end-stop, and a retracted position corresponding to a load that is in abutment against said end-stop. The end-stops 6 are mounted at the lower end of the uprights 4′a, 4′b. In FIG. 1, for the purposes of understanding, one of the end-stops 6 is depicted in the deployed position and the other end-stop is depicted in the retracted position.

As is known per se, the truck 1 is equipped with a drive system 7 enabling the truck 1 to move. The drive system comprises at least one electric motor or combustion engine (not depicted) providing drive to the wheels (not referenced) of the truck 1.

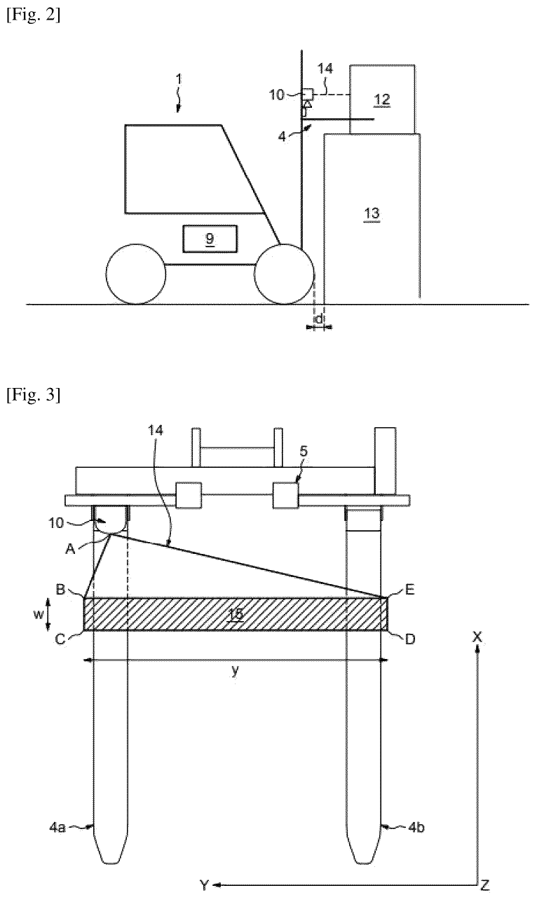

The truck 1 is also equipped with an on-board locator device 8 and with an on-board control unit 9 (FIG. 2) receiving information coming from the locator device 8 in order to autonomously command the movement of the lift truck.

The control unit 9 comprises the hardware and software means required for commanding the operation of the drive system 7 on the basis of the information received from the locator device 8. The control unit 9 is also able to command the automatic movement of the fork 4.

The truck 1 is also equipped with a contactless detection device 10 which is positioned above the blades 4a, 4b of the fork 4. The detection device 10 is fixed on the upright 4′a of the fork and is situated above the blades 4a, 4b. In the exemplary embodiment illustrated, the detection device 10 is fixed to the upright 4′a above the associated end-stop 6. The contactless detection device 10 is able to move together with the upright 4′a of the fork. The detection device 10 is distinct from the locator device 7.

As will be described in greater detail later, the detection device 10 is able to emit a beam of light that sweeps at least one predefined planar detection zone situated above the blades 4a, 4b so as to detect the presence of a load that is to be lifted by means of said load intersecting the beam of light inside said predetermined planar detection zone.

The detection device 10 is configured to acquire position data pertaining to the position of the load that is to be lifted, and to transmit to the control unit 9 information indicative of the presence or absence of the load detected inside the predefined planar detection zone. On the basis of the information received, the control unit 9 then commands the operation of the drive system 7 and the vertical movement of the fork 4. The detection device 10 may for example be a laser sensor of the lidar type.

The principle of operation of the autonomous lift truck 1 for detecting the presence or absence of a load 12 that is to be lifted on shelving 13 will now be described with reference to FIGS. 2 and 3.

In an initial phase, the control unit 9 commands the operation of the truck 1 to make it move in close to the shelving 13 and to raise the blades of the fork 4 in order to position them relative to the load 12 that is to be lifted. The truck 1 is commanded by the control unit 9 on the basis of the data coming from the locator device 8. As it moves, the truck 1 is commanded to maintain a minimum safe distance d from the shelving 13. During the initial phase, the truck 1 is commanded to maintain a minimum safe horizontal distance between the overhanging end of the blades of the fork 4 and the shelving 13 so as to allow the blades to pass safely over the shelving 13.

Next, the detection device 10 emits a beam of light 14 that sweeps at least a first planar predefined detection zone 15 situated above the blades 4a, 4b of the fork. The vertical projection of the detection zone 15 covers the blades 4a, 4b of the fork and the transverse space separating these blades.

In the exemplary embodiment illustrated, the detection zone 15 is defined by four distinct points delimiting a rectangle, such as the points B, C, D and E in FIG. 3. The point A schematically indicates the point at which the beam of light 14 leaving the device 10 is emitted. The detection zone 15 is horizontal here. Alternatively, it could be possible to envisage a zone 15 that is inclined with respect to the horizontal.

The long side of the rectangle delimited by the points B, C, D and E has a length y greater than the transverse spread of the blades 4a, 4b of the fork, and the detection zone 15 is centred relative to these blades. In other words, the planar detection zone 15 extends laterally beyond the transverse spread of the blades 4a, 4b of the fork. By way of indication, the width w of the short side of the rectangle delimited by the points B, C, D and E, and therefore the depth of the detection zone 15, may be equal to 50 mm.

The detection device 10 is configured to detect whether the load 12 lies inside the detection zone 15. The load 12 is detected by the device 10 as being present when it intersects the ray of light 14 and at the same time lies inside the detection zone 15. The detection device 10 is able to detect that the load lies inside the first detection zone 15 using a distance measurement.

If the load does not intersect the ray of light 14 emitted by the device 10, or if this intersection exists but the detection device 10 detects that the distance separating said device from the load 12 is outside of the predefined planar detection zone 15, then the device 10 detects that the load 12 is absent from said detection zone.

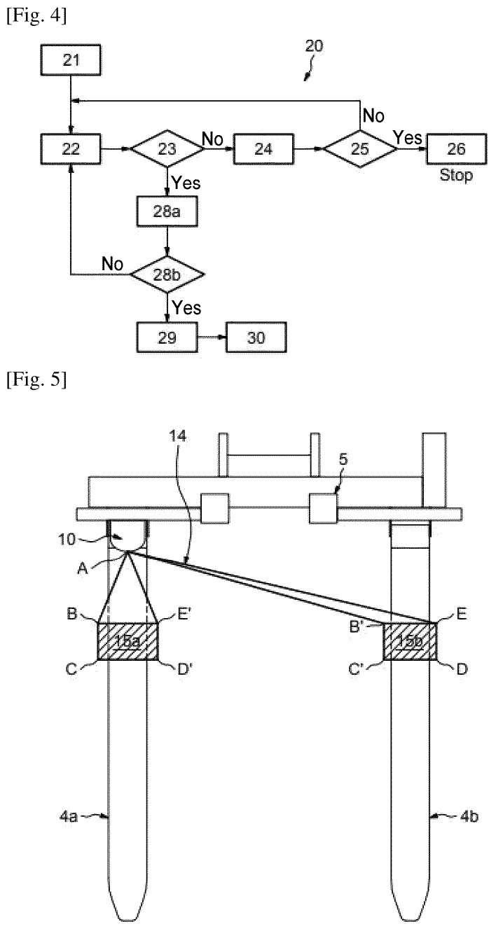

A method 20 for lifting and transporting a load using the autonomous lift truck 1 will now be described. The method 20 is illustrated in FIG. 4.

The method 20 starts with the pre-positioning step 21 during which the control unit 9 operates the truck 1 to position it aligned beneath the load 12 that is to be lifted and to position the blades 4a, 4b of the fork 4 vertically level with this load.

During the next positioning step 22, the control unit 9 operates the truck 1 in order to cause the blades 4a, 4b to move closer to the load 12.

The method then continues with a first step 23 of detection of the load performed by the device 10. The device 10 detects whether the load 12 lies inside the detection zone 15 (FIG. 3). Such is the case if the load 12 intersects the ray of light 14 emitted by the device 10 and if the load is situated inside the detection zone 15. The device 10 transmits to the control unit 9 the information indicative of the presence or absence of the load that is to be lifted in the detection zone 15.

If the load 12 is not detected inside the detection zone 15 by the device 10, the control unit 9 in step 24 sets a timeout value T equal to a predetermined value t. The predetermined value t can be configured by the control unit 9 on the basis of the speed of travel of the truck 1. The control unit 9 uses sensors (not referenced) to verify, in the next step 25, whether the minimum safe distance d has been reached or whether the imaginary destination point has been reached. If it has, the control unit 9 stops the truck 1 in step 26 so as to allow an operator to re-establish correct operation. If it has not, the control unit 9 operates the truck 1 to continue to move the blades 4a, 4b closer to the load 12, by resuming from step 22.

In the embodiment illustrated, if the load 12 is detected inside the detection zone 15 by the device 10 during step 23, the control unit 9 decreases the timeout value T by a predetermined value x during a step 28a, and in the next step 28b verifies whether the time value T is less than or equal to 0. If it is not, the control unit 9 operates the truck 1 to continue to move the blades 4a, 4b closer to the load 12, by resuming from step 22.

If it is, that means that the timeout time has elapsed, and the control unit 9 lifts the load by issuing an instruction to lift in step 29. Next, the control unit 9 commands the movement of the truck 1 and the transporting of the load during step 30. To do that, the control unit 9 makes use of the information received from the locator device 8 in order to move the lift truck 1 towards the intended destination of the load 12 that is to be transported.

In the embodiment described, the method comprises a detection step 23 followed by a timeout step. As a variant, the method may comprise only the detection step 23, without recourse to a timeout.

In the embodiment described, the timeout T is initialized after the detection step 23 when no load is detected in the detection zone 15. As a variant, the method could involve initializing the timeout prior to the positioning step 22.

In the embodiment described, in the detection step 23, the detection zone 15 of the detection device is common to the two blades 4a and 4b of the fork 4. In other words, the vertical projection of the detection zone 15 covers the blades 4a, 4b of the fork and the transverse space separating these blades.

As a variant, it would be possible to provide, for each of the blades 4a, 4b of the fork, a first detection zone specific to it. In other words, the detection device 10 (FIGS. 1 and 2) is able to emit a beam of light that sweeps a first detection zone 15a specific to the blade 4a of the fork and situated above this blade 4a, and a first zone 15b specific to the blade 4b, situated above this blade 4b and distinct from the first detection zone 15a, as illustrated in FIG. 5.

The vertical projection of the first detection zone 15a covers the blade 4a of the fork and the vertical projection of the first detection zone 15b covers the blade 4b. The first zone 15a here is defined by four distinct points defining a rectangular zone, such as B, C, D′ and E′, and the second zone 15b is defined by four distinct points defining another rectangular zone, such as B′, C′, D and E.

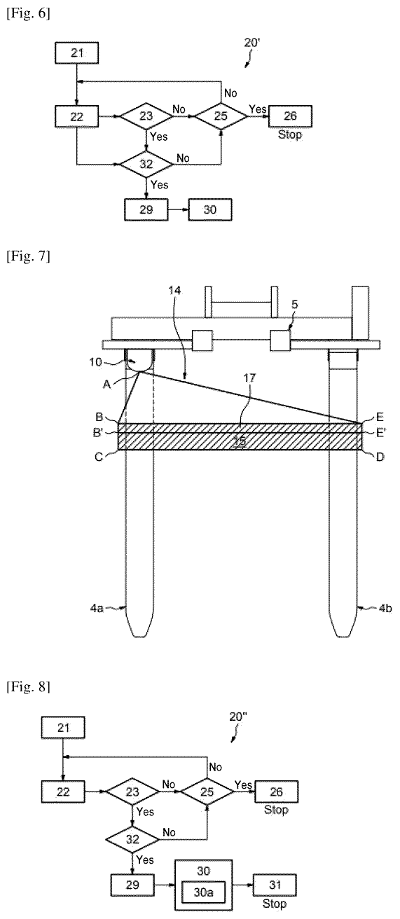

In another variant embodiment of the method of FIG. 4, illustrated in FIG. 6, in which the identical steps bear the same references, a second detection step 32 is provided and during that step the device 10 detects the load 12 inside a second detection zone 17 illustrated in FIG. 7. In this embodiment, there is no timeout step.

In the exemplary embodiment illustrated, this second detection zone 17 is defined by four distinct points delimiting a rectangle having a long side common to the rectangle defined by the points B, C, D and E of the first detection zone 15. The second detection zone 17 is defined by the points E, B, B′, E′. The second detection zone 17 is situated inside the first zone 15 and on the side of the detection device 10. The width of the short side of the rectangle delimited by the points E, B. B′, E′ is less than that of the short side of the rectangle delimited by the points B, C, D and E.

Referring once again to FIG. 6, if the load 12 is not detected inside the second detection zone 17 during the detection step 32, the method resumes from step 25 and then the control unit 9 causes the blades 4a, 4b to move closer to the load 12 by resuming from step 22 if the minimum safe distance d has not been reached.

If the load 12 is detected inside the second detection zone 17 during the detection step 32, the control unit 9 performs the lifting of the load by issuing an instruction to lift (step 29), and then commands the moving of the truck 1 and the transporting of the load, during step 30.

In this embodiment, the first and second detection zones 15, 17 are each common to the two blades 4a and 4b of the fork 4. Alternatively, it would also be possible to provide first detection zones each specific to one of the blades 4a, 4b as described previously, and second detection zones likewise each specific to one of the blades 4a, 4b.

In another variant embodiment of the method, illustrated in FIG. 8, in which the identical steps bear the same references, a sub-step 30a of checking the position of the load 12 is provided during step 30 of transporting of the load.

During the sub-step 30a, the detection device 10 may perform detection of the load 12 using the detection zone 15 described earlier. If the load is not detected in the zone 15, the control unit 9 considers that the load 12 cannot be transported safely because this non-detection is indicative of a slippage of the load, and said unit issues an instruction to stop so that an operator can re-establish correct operation.

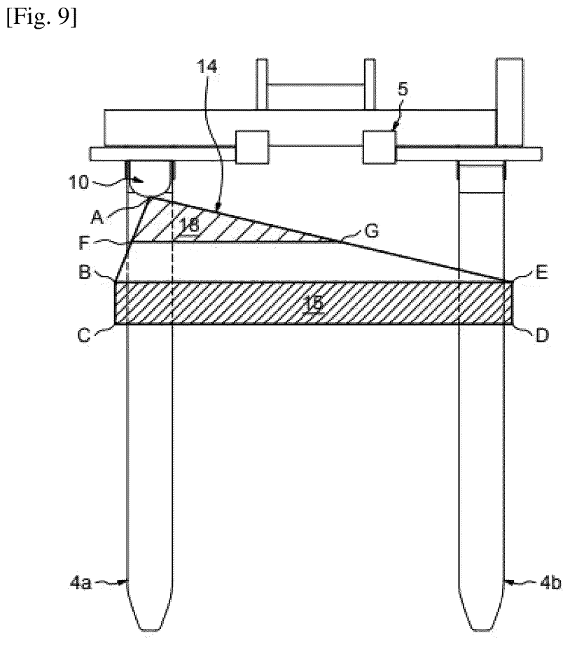

Alternatively, during the sub-step 30a, the detection device 10 may perform detection of the load 12 using a detection zone 18 indicative of a slippage of the load, situated outside the first detection zone 15 and corresponding to the triangle AFG, as illustrated in FIG. 9. This detection zone 18 is situated on the side of the detection device 10 and at a distance from the rectangle defined by the points B, C, D and E of the first detection zone 15.

If the load is detected in the detection zone 18 indicative of slippage of the load, the control unit 9 considers that the load has slipped during transport and in step 31 of the method issues an instruction to stop the truck 1 so that an operator can re-establish correct operation.

In another embodiment of the method, it is possible to provide, during step 30 of transporting of the load, a sub-step of checking for any rotation of the load. This is possible when each of the blades 4a, 4b of the fork has its own specific detection zone associated with it, as described above.

In that case, during the step 30 of transporting of the load, if the load is not detected in the two detection zones associated with the two blades 4a, 4b of the fork simultaneously, the control unit 9 considers that the load has rotated about the vertical axis Z during transport, and issues an instruction to stop the truck 1 in step 31 of the method so that an operator can re-establish correct operation.

1.-15. (canceled)

16. An autonomous lift truck comprising:
a vertically mobile fork equipped with at least two blades for lifting loads;
a drive system for moving the lift truck;
a control unit able to command operation of the drive system for autonomously guiding the lift truck and able to command vertical movement of the vertically mobile fork; and
a contactless load-detection device, the contactless load-detection device being able to move together with the vertically mobile fork and positioned above the at least two blades of the vertically mobile fork, the contactless load-detection device being able to emit a beam of light that sweeps at least a predefined planar detection zone situated above at least one of the blades so as to detect a presence or absence of a load that is to be lifted,
wherein the control unit receives information indicative of the presence or absence of the load that is to be lifted in the predefined planar detection zone from the contactless load-detection device and is able to command the operation of the drive system and the vertical movement of the vertically mobile fork on the basis of the information.

17. The autonomous lift truck according to claim 16, wherein the predefined planar detection zone swept by the beam of light emitted by the contactless load-detection device is horizontal.

18. The autonomous lift truck according to claim 16, wherein the vertically mobile fork comprises at least two uprights supporting the at least two blades, the contactless load-detection device being placed on one of the at least two uprights.

19. The autonomous lift truck according to claim 18, further comprising an end-stop placed on each of the uprights of the vertically mobile fork and mounted with an ability to pivot between a deployed position corresponding to a load that is absent or not in abutment against an end-stop, and a retracted position corresponding to a load that is in abutment against an end-stop, the contactless load-detection device placed on an upright being situated above an associated end-stop.

20. The autonomous lift truck according to claim 16, further comprising an on-board locator device configured to acquire position data pertaining to a position of the lift truck and communicating with the control unit, the contactless load-detection device being distinct from the locator device.

21. A method for lifting and transporting a load using the autonomous lift truck according to claim 16, the method comprising:
a step of positioning of the at least two blades of the vertically mobile fork with respect to the load;
at least a first step of detecting the load using the contactless load-detection device;
a step of lifting the load if the load is detected in at least a first predefined planar detection zone swept by the beam of light emitted by the contactless load-detection device in the first detecting step; and
a step of moving the autonomous lift truck and of transporting the load.

22. The method according to claim 21, wherein the first predefined detection zone is defined by four points delimiting a rectangle.

23. The method according to claim 21, further comprising, prior to the step of lifting the load, a second step of successive detection of the load by the contactless load-detection device, the step of lifting the load being performed if the load is detected during the second detection step.

24. The method according to claim 21, wherein the step of lifting the load is performed after a timeout step, which is performed after the first detecting step.

25. The method according to claim 23, wherein the second load-detection step is performed in at least a second predefined detection zone situated inside the first detection zone on a side of the contactless load-detection device.

26. The method according to claim 21, wherein the load-detection step is performed in a planar detection zone that is common to the at least two blades of the vertically mobile fork.

27. The method according to claim 21, wherein the load-detection step is performed in two planar detection zones, each specific to one of the at least two blades of the vertically mobile fork.

28. The method according to claim 27, further comprising, during the step of moving the autonomous lift truck and of transporting the load, a sub-step of checking rotation of the load, performed by the contactless load-detection device, the checking of the rotation of the load being performed with respect to each detection zone that is specific to one of the at least two blades of the vertically mobile fork, the step of moving the autonomous lift truck and of transporting the load being halted if the load is not detected in the two detection zones simultaneously.

29. The method according to claim 21, further comprising, during the step of moving the autonomous lift truck and of transporting the load, a sub-step of checking of a position of the load, performed by the contactless load-detection device, the checking of the position of the load being performed with respect to the first detection zone, the step of moving the autonomous lift truck and of transporting the load being halted if the load is not detected in the first detection zone.

30. The method according to claim 21, further comprising, during the step of moving the autonomous lift truck and of transporting the load, a sub-step of checking of a position of the load, performed by the contactless load-detection device, the checking of the position of the load being performed with respect to at least one predefined detection zone indicative of a slippage of the load and situated outside the first detection zone on a side of the contactless load-detection device, the step of moving the autonomous lift truck and of transporting the load being halted if the load is detected in the predefined detection zone indicative of a slippage of the load.
